(19) United States
(12) Patent Application Publication
(10) Pub. No.: US 2010/0279037 A1
(43) Pub. Date: Nov. 4, 2010

(54) MULTI-LAYERED GLASS STRUCTURE

(76) Inventors: Chung-Hsien Huang, Tucheng City (TW); Cheng-Chieh Kao, Jhongli City (TW); Ming-Chun Ho, Pingjhen City (TW); Chih-Che Kuo, Taipei City (TW)

Correspondence Address: NIKOLAI & MERSEREAU, P.A., 900 SECOND AVENUE SOUTH, SUITE 820, MINNEAPOLIS, MN, 55402, US

(21) Appl. No.: 12/432,161

(22) Filed: Apr. 29, 2009

(51) Int. Cl. E06B 3/66

(52) U.S. Cl. 428/34

(57) ABSTRACT

A multi-layered glass structure includes at least three glass substrates. The edges of the three glass substrates are sealed and fastened. There is a cavity space between two adjacent glass substrates, and the multi-layered glass structure includes at least one vacuum cavity space. The multi-layered glass structure has a flat vacuum structure to enhance the heat insulation and separating effect and the noise insulation effect of the multi-layered glass structure.

### BACKGROUND OF THE INVENTION

1. Field of the Invention

The present invention relates to a multi-layered glass structure. In particular, the present invention relates to a multi-layered glass structure that is flat and has a vacuum cavity space.

2. Description of Related Art

As technology has been developing, the usage of power steadily increases. Currently, oil is the main source for power. As the consumption of power increases, International Energy Agency forecasts that the consumption of power will double after 20 years. Therefore, governments and private groups are keen on promoting the importance of power saving. By reducing the consumption of power, greenhouse effect may be lessened, and enterprises and person also can thereby reduce the cost related to power usage.

According to statistical data, the exhaustion quantity of carbon dioxide from the construction industry in Taiwan is 24.3% of total exhaustion quantity (construction manufacturing is 9.4%, construction transmission is 0.53%, household usage is 10.3%, business usage is 4.1%). The exhaustion quantity of carbon dioxide from the construction industry seriously affects the environment. Therefore, power saving regarding construction is to be a main focus of environmental protection policy. For example, a great amount of plants are planted in the downtown. Plants can absorb carbon dioxide, reduce greenhouse gas to lower greenhouse effect, and reduce the power consumption from air conditioners. When a lot of plants and trees are planted around our living area, it can contribute to one's peace of mind, promote activity of soil microorganisms, provide a great amount of oxygen, and absorb carbon dioxide. It is good for global environmental protection. Furthermore, natural soil in the construction foundation and the covered soil on housetop, balcony, outer wall, or artificial ground can be used to plant a variety of plants so as to facilitate the greening of the construction foundation.

Moreover, by designing power-saving structure on buildings, the power consumption for air conditioners and lighting devices can be reduced. The power saving effect of the outer walls of buildings is thereby enhanced.

Although the glass windows and doors of buildings are a double-layered glass for heat insulation and separation, the effect of heat insulation and separation may not be enough due to gas with high heat-resistance, such as air or nitrogen, which flows into the double-layered glass windows and doors. Alternatively, by increasing the gap between two glasses, or the thickness of glasses to improve this problem, then other associated problems may occur, such as the thickness and the weight of the glass windows and doors increases. Therefore, there are some problems for using or producing the glass windows and doors that must balance the object of heat insulation and maintain the thinness and lightness of glass.

### SUMMARY OF THE INVENTION

One particular aspect of the present invention is to provide a multi-layered glass structure. The multi-layered glass structure is flat. The multi-layered glass structure includes at least one vacuum cavity space with high heat-resistance so as to solve the problems of hollow glass of the prior art that cannot provide a high heat insulation and noise insulation effect. The multi-layered glass structure can be applied to building glass to increase ambient light in the building.

The multi-layered glass structure includes at least three glass substrates. The edges of the three glass substrates are sealed and fastened. There is a cavity space between two adjacent glass substrates, and the multi-layered glass structure includes at least one vacuum cavity space.

The multi-layered glass structure of the present invention is a flat structure, and has at least one vacuum cavity space. The vacuum cavity space of the multi-layered glass structure has high heat-resistance to achieve a better heat insulation and noise insulation effect. Furthermore, the multi-layered glass structure is pervious to light so as to facilitate an increase of the ambient light in the building.

For further understanding of the present invention, reference is made to the following detailed description illustrating the embodiments and examples of the present invention. The description is for illustrative purpose only and is not intended to limit the scope of the claim.

### BRIEF DESCRIPTION OF THE DRAWINGS

FIG. 1 is a schematic diagram of a multi-layered glass structure of a first embodiment of the present invention;

FIG. 1A is a schematic diagram of another embodiment of FIG. 1;

FIG. 1B is a schematic diagram of a further embodiment of FIG. 1;

FIG. 2 is a schematic diagram of the multi-layered glass structure of a second embodiment of the present invention;

FIG. 3 a schematic diagram of the multi-layered glass structure of a third embodiment of the present invention;

FIG. 4 is a schematic diagram of the multi-layered glass structure of a fourth embodiment of the present invention.

### DETAILED DESCRIPTION OF THE PREFERRED EMBODIMENTS

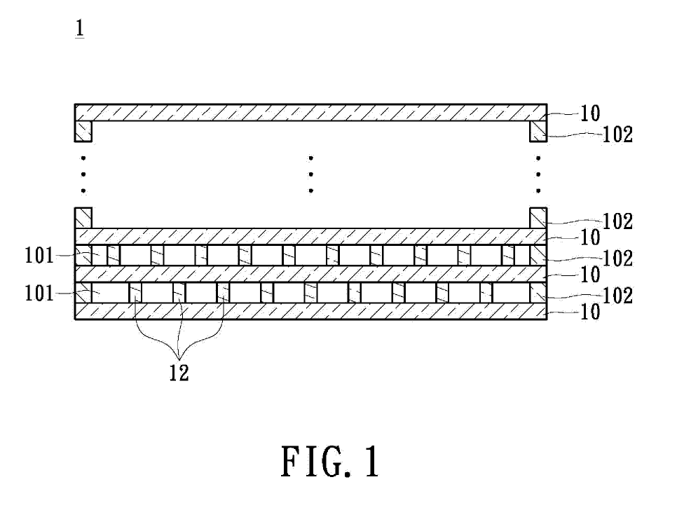

Reference is made to FIG. 1. The present invention provides a multi-layered glass structure 1. The multi-layered glass structure 1 is flat and has a high heat insulation and noise insulation effect. The multi-layered glass structure 1 is applied as green building material to green construction, such as doors and windows of buildings, wherein the multi-layered glass structure 1 provides good heat insulation, noise insulation, and indoor illumination. The multi-layered glass structure 1 includes at least three glass substrates 10. The edges of the three glass substrates 10 are sealed and fastened to form at least one vacuum cavity space 101. Because the coefficient of the heat-resistance is very large (much larger than the coefficient of the heat-resistance of gas), the heat insulation effect and the noise insulation effect are good due to the utilizing of the high heat-resistance coefficient.

Reference is made to FIG. 1 again, which shows a schematic diagram of the multi-layered glass structure of a first embodiment of the present invention. In this embodiment, the multi-layered glass structure 1 is flat (composed of a plurality of glass substrates 10). The multi-layered glass structure 1 is composed of a plurality of glass substrates 10 that are correspondingly located. The edges of the glass substrates 10 that are adjacent are sealed by heat insulation glue 102, and gas in the glass substrates 10 that are sealed is then fully exhausted to form the vacuum cavity space 101. Furthermore, each of the vacuum cavity spaces 101 has a plurality of supporting spacers 12. Two ends of each supporting spacers 12 respectively contacts the inner surfaces of two adjacent glass substrate 10, so as to provide the supporting force when the multi-layered glass structure 1 is formed, and thereby prevent the multi-layered glass structure 1 from being deformed or broken. The quantity of the supporting spacers 12 affects the thermal conductivity (K). When the quantity of the supporting spacers 12 is few, the thermal conductivity (K) of the multi-layered glass structure 1 is small. In one embodiment, the supporting spacers 12 are made of heat insulating material to reduce the path for conducting heat. Therefore, the quantity of the supporting spacers 12 is reduced as far as possible but can still overcome the pressure difference. Thereby, the light transparency of the multi-layered glass structure 1 is good. At the same time, the heat insulation effect and the noise insulation effect is achieved by utilizing the vacuum cavity space 101.

The shape of the supporting spacers 12 can be circular, spherical, C-shaped (viewed from a direction that is vertical to the multi-layered glass structure 1), concentric circle (viewed from a direction that is vertical to the multi-layered glass structure 1), cross-shaped (viewed from a direction that is vertical to the multi-layered glass structure 1), or horseshoe-shaped (viewed from a direction that is vertical to the multi-layered glass structure 1), etc. In one preferred embodiment, the shape of the supporting spacers 12 is C-shaped due to the required area for the C-shaped supporting spacers 12 is the smallest. In other words, the supporting force per unit dimension is high, so that the supporting spacers with few quantities can support the multi-layered glass structure 1. The light transparency of the multi-layered glass structure 1 is not lowered. Moreover, in this embodiment, the supporting spacers 12 located in the vacuum cavity space 101 are crossly disposed, and the vacuum pressure of the vacuum cavity space 101 is below 10⁻² torr.

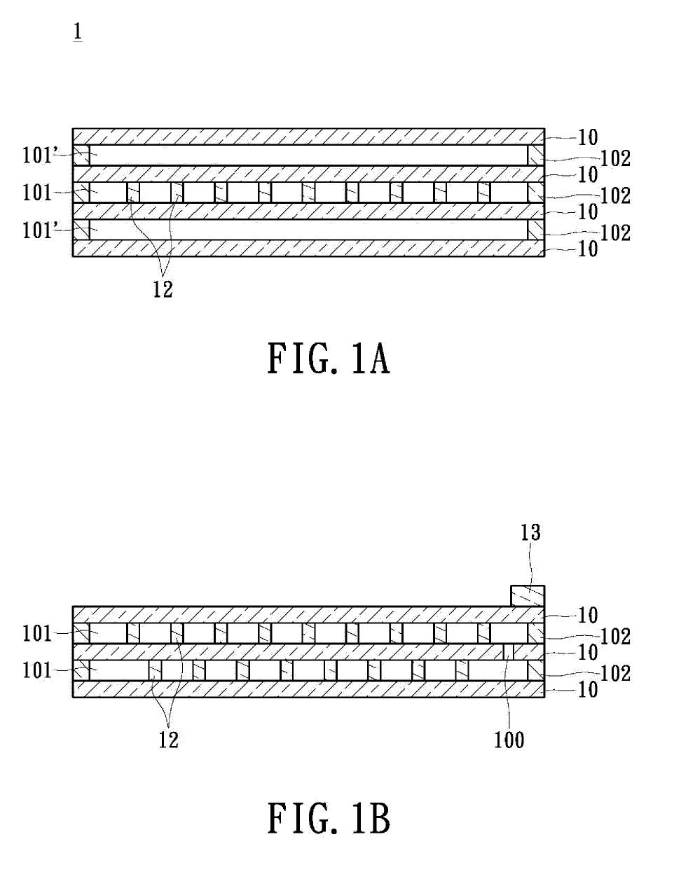

Reference is made to FIG. 2, which shows a second embodiment of the present invention. The difference between the second embodiment and the first embodiment is described as follow. The supporting spacers 12 that are located in the vacuum cavity space 101 are aligned. Comparing to the first embodiment, the vertical light transparency is high and the heat insulation effect is low. The other characteristics are the same as the first embodiment.

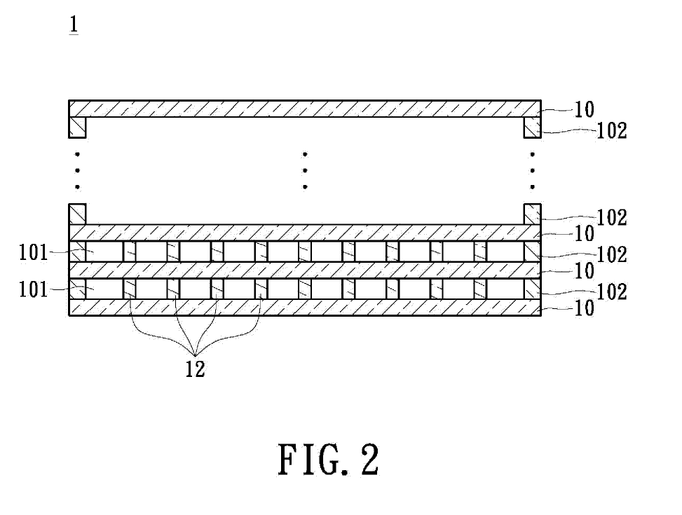

Reference is made to FIG. 3, which shows the multi-layered glass structure 1 in a third embodiment of the present invention. The multi-layered glass structure 1 is flat (composed of a plurality of glass substrates 10). The multi-layered glass structure 1 is composed of plurality of glass substrates 10 that are correspondingly located. The edges of the glass substrates 10 are sealed by a glass frame 103, and gas in the glass substrates 10 that are sealed is fully exhausted to form the vacuum cavity space 101 so that the vacuum pressure of the vacuum cavity space 101 is below 10⁻² torr. The appearance and the disposition of the supporting spacers 12 are the same as the first embodiment; therefore the description is not repeated.

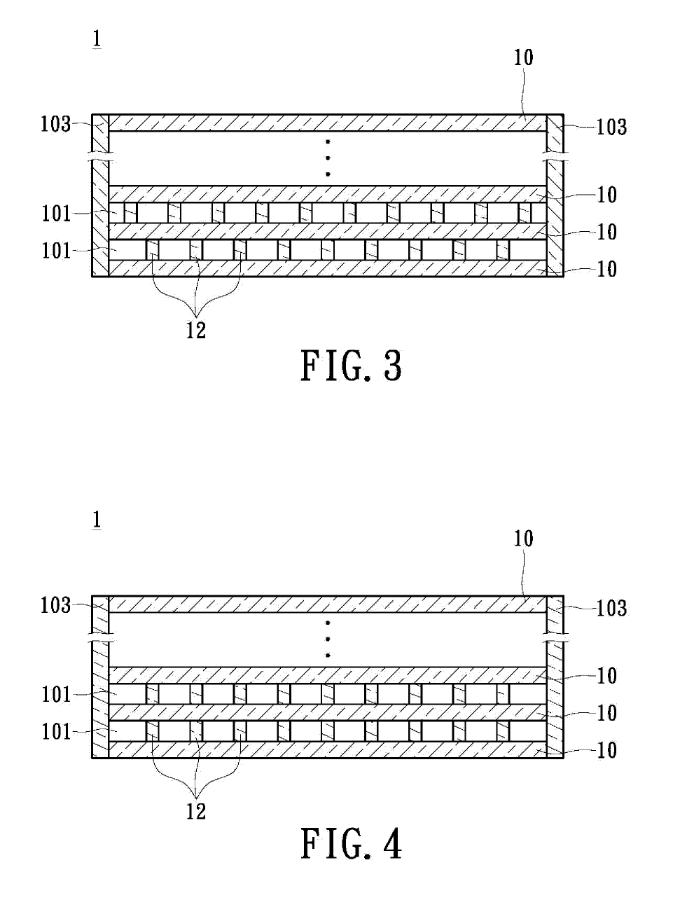

Reference is made to FIG. 4, which shows a fourth embodiment of the present invention. The difference between the fourth embodiment and the third embodiment is described as follow. The supporting spacers 12 that are located in the vacuum cavity space 101 are aligned, and the other characteristics are the same as the third embodiment, therefore the description is not repeated.

Reference is made to FIGS. 1 and 1A. FIG. 1A shows a schematic diagram of another embodiment of FIG. 1. The multi-layered glass structure 1 includes four glass substrates 10 that are correspondingly disposed. The four glass substrates 10 form three cavity spaces. One of the cavity spaces is a vacuum cavity space 101 and two of the cavity spaces are general hollow cavity space 101′ (being not in a vacuum state). In other words, the cavity spaces formed by the glass substrates 10 are not all limited to being in a vacuum state. The multi-layered glass structure 1 merely includes at least one vacuum cavity space 101 to achieve the heat insulation and noise insulation effect. Furthermore, only the vacuum cavity space 101 of the cavity spaces formed by the glass substrates 10 needs to be located with the supporting spacers 12.

The manufacturing process for the multi-layered glass structure 1 is illustrated in detail as follow.

Step (a): A glass substrate 10 with 99.5% light transparency is provided. A plurality of supporting spacers 12 that are convex are processed on the inner surface of another glass substrate 10 with 99.5% light transparency. The shape of the supporting spacers 12 can be circular, spherical, C-shaped, concentric circle, cross-shaped (i.e., t-shaped), horseshoe-shaped (i.e., Q-shaped), semi-spherical, or water-drop shaped, etc. The supporting spacers 12 are formed on the inner surface of the glass substrate 10 in a matrix disposition or other disposition. The external surface of one of the two glass substrates 10 has an air-exhausting structure 13 (referring to FIG. 1B), such as an air-exhausting pipe. The present invention does not limit the location of the supporting spacers 12 to a specific type. The supporting spacers 12 can be formed on the inner surface of one of the glass substrates 10, or formed on the inner surfaces of the two glass substrates 10.

Step (b): The inner surfaces of the two glass substrates 10 are located face to face so that the top end of the supporting spacers 12 located at the inner surface of one glass substrate 10 contacts the inner surface of another glass substrate 10. The edges of the two glass substrates 10 are sealed by heat insulation glue 102, or a glass frame 103. The external gas-exhausting unit exhausts air between the two glass substrates 10 via the gas-exhausting structure 13 so as to form a vacuum cavity space 101. The vacuum pressure of the vacuum cavity space 101 is under 10⁻² torr to prevent the heat convention and heat transmission from occurring. The location of the gas-exhausting structure 13 can be above the glass substrate 10, at the corners of the glass substrate 10, or at the sides of the glass substrate 10, and is implemented by pipe-less package way. Finally, a stacking way is used for stacking the above structures to form the multi-layered glass structure 1. The width of the vacuum cavity space 101 can be adjusted according to the application. For example, in this embodiment, the width of the vacuum cavity space 101 is between 0.1 mm and 0.5 mm.

Reference is mad to FIG. 1B. The multi-layered glass structure 1 also can be manufactured by the following way. Firstly, a plurality of glass substrates 10 (such as three glass substrates), the supporting spacers 12, and the heat insulation glue on the edges of the glass substrates 10 are constructed to form the structure of the multi-layered glass structure 1. One of the glass substrates 10 has a gas-exhausting structure 13. The glass substrate 10 that is located in the multi-layered glass structure 1 has a through hole 100. The external gas-exhausting unit exhausts air between the glass substrate 10 via the gas-exhausting structure 13 to form two vacuum cavity spaces 101. Finally, the gas-exhausting structure 13 is sealed. The present invention can utilize the through hole 100 (the quantity and shape of the through holes is not limited to a specific one) on the glass substrate 10 to perform the gas-exhausting operation to the gas-exhausting structure 13 that is stacked. Thereby, the efficiency for manufacturing the multi-layered glass structure 1 can be improved.

The present invention has the following characteristics.

1. The multi-layered glass structure of the present invention is a flat structure, and has at least one vacuum cavity space. By utilizing the vacuum cavity space, the multi-layered glass structure has the heat insulation effect and the noise insulation effect. Furthermore, the supporting spacers made of heat insulating material in the vacuum cavity space between the glass substrates and the edges of the glass substrates that are sealed by heat-separating glue can reduce the path for transmitting heat.

2. The multi-layered glass structure can be applied to a variety of heat insulation, and noise insulation fields, such as green building materials—glass of buildings). By utilizing the high light transparency of the multi-layered glass structure, the ambient light in the building is improved. Furthermore, the multi-layered glass structure utilizes the high heat-resistance of the vacuum cavity space and because it only requires a few supporting spacers in the vacuum cavity space, thereby the transmission of noise is reduced. The end result is the lowering of external noise influence and the lowering of high temperature influence to the indoor environmental.

The description above only illustrates specific embodiments and examples of the present invention. The present invention should therefore cover various modifications and variations made to the herein-described structure and operations of the present invention, provided they fall within the scope of the present invention as defined in the following appended claims.

What is claimed is:

1. A multi-layered glass structure, comprising:
at least three glass substrates, wherein edges of the three glass substrates are sealed and fastened, there is a cavity space formed between every two adjacent glass substrates, and the multi-layered glass structure includes at least one vacuum cavity space.

2. The multi-layered glass structure as claimed in claim 1, further comprising a plurality of supporting spacers located in the vacuum cavity space, wherein two ends of the supporting spacers respectively contact the two adjacent glass substrates that form the vacuum cavity space.

3. The multi-layered glass structure as claimed in claim 2, wherein the supporting spacers are made of heat insulating material.

4. The multi-layered glass structure as claimed in claim 3, wherein the supporting spacers is circular, spherical, C-shaped, concentric circle, cross-shaped, or horseshoe-shaped.

5. The multi-layered glass structure as claimed in claim 2, wherein the supporting spacers located in the vacuum cavity space are crossly disposed or aligns to each other.

6. The multi-layered glass structure as claimed in claim 2, wherein the edges of the two glass substrates that are adjacent are sealed by heat insulation glue.

7. The multi-layered glass structure as claimed in claim 2, wherein the edges of the at least three glass substrates that are adjacent are sealed by a glass frame.

8. The multi-layered glass structure as claimed in claim 2, wherein the multi-layered glass structure is a flat multi-layered glass structure.

9. The multi-layered glass structure as claimed in claim 2, wherein the vacuum pressure of the vacuum cavity space is under 10⁻² torr.

10. The multi-layered glass structure as claimed in claim 2, wherein the glass substrate located in the multi-layered glass structure further comprises at least one through hole.
